(19) United States
(12) Patent Application Publication
(10) Pub. No.: US 2026/0274580 A1
(43) Pub. Date: Sep. 17, 2026

(54) NECKED DOWN ROLLER SHEAVE

(71) Applicant: Lewco, Inc., Sandusky, OH (US)

(72) Inventors: Gerald T. Guerra, Sandusky, OH (US); Nathan Cole Feaser, Carlisle, PA (US)

(21) Appl. No.: 19/567,219

(22) Filed: Mar. 15, 2026

Related U.S. Application Data
(60) Provisional application No. 63/772,693, filed on Mar. 16, 2025.

(51) Int. Cl. B65G 39/02

(52) U.S. Cl. CPC B65G 39/02

(57) ABSTRACT

A conveyor system includes a frame, a plurality of rollers, and a guardrail. The frame has a first side and an opposing second side. The rollers are mounted between the first side of the frame and the opposing second side of the frame. The rollers form a conveying surface. Moreover, the rollers comprise respective tube portions and necked down sheaves mounted to the tube portions. The guardrail comprises a vertical side wall, where the guardrail is coupled to the first side of the frame. The vertical side wall of the guardrail is perpendicular to the conveying surface. The vertical side wall comprises a bottom edge, where at least a portion of the bottom edge of the vertical side wall includes a scalloped perimeter. The scalloped perimeter and necked down sheaves are aligned such that the bottom edge of the vertical side wall extends below top surfaces of the rollers.

### RELATED APPLICATION

This application claims priority to U.S. Provisional Patent Application No. 63/772,693, filed on Mar. 16, 2025, and entitled “NECKED DOWN ROLLER SHEAVE,” the entirety of which is incorporated herein by reference.

### BACKGROUND

Conveyor systems can be used in various commercial and manufacturing applications to transport conveyed articles between different locations. Conventional conveyor systems commonly convey large numbers of conveyed articles at high speed. The conveyed articles can have various sizes, weights, shapes, rigidities, and so forth. The conveyed articles can include packages, products, equipment, or the like.

Roller conveyors are commonly employed for material handling to transport conveyed articles from one location to another location. Conventional roller conveyors often include a series of tubular rollers. For certain material handling applications, the rollers are driven by a multi-V belt torque transmitting mechanism. The torque transmitting mechanisms typically engage with roller sheaves of the rollers in the series.

Commonly, a particular roller in the series is a directly driven roller that is driven by a motor. Other rollers in the series are peripherally driven by the directly driven roller through the use of multi-V belts. For example, a directly driven roller in the series is driven by a motor. Following this example, a first multi-V belt couples a sheave of the directly driven roller to a sheave of a first peripherally driven roller adjacent to the directly driven roller in the series. As a result, the first peripherally driven roller is driven by the directly driven roller. Further pursuant to this example, a second multi-V belt couples the sheave of the first peripherally driven roller to a sheave of a second peripherally driven roller adjacent to the first peripherally driven roller. Again, the second peripherally driven roller is driven by the first peripherally driven roller. The multi-V belts are continually used to couple sheaves of adjacent rollers in the series of rollers.

Some conventional conveyor systems include roller conveyors and guardrails adjacent to sheaves of rollers. For instance, a traditional guardrail can include a vertical side wall. The guardrail can be disposed above sheaves of rollers in a series of rollers included as part of a conventional roller conveyor such that the vertical side wall can be perpendicular to a conveying surface formed by the series of rollers. However, gaps often exist in these conventional conveyor systems between a top of the conveying surface and a bottom edge of the vertical side wall. The gaps can detrimentally impact performance and safety of these conventional conveyor systems. For instance, a conveyed article being conveyed along the conveying surface can become caught in a gap between the top of the conveying surface and the bottom edge of the vertical side wall of the guardrail, which can detrimentally impact the flow of conveyed articles by causing a jam of the conveyed articles. Moreover, the gap can pose a risk for pinching an article of clothing or a body part (e.g., finger) of a person nearby the conventional conveyor system.

### SUMMARY

The following is a brief summary of subject matter that is described in greater detail herein. This summary is not intended to be limiting as to the scope of the claims.

According to various embodiments, a conveyor system that includes a frame, a plurality of rollers, and a guardrail is described herein. The frame has a first side and an opposing second side. The rollers are mounted between the first side of the frame and the opposing second side of the frame. The rollers form a conveying surface. Moreover, the rollers comprise respective tube portions and necked down sheaves mounted to the tube portions. The guardrail comprises a vertical side wall, where the guardrail is coupled to the first side of the frame. The vertical side wall of the guardrail is perpendicular to the conveying surface. The vertical side wall comprises a bottom edge, where at least a portion of the bottom edge of the vertical side wall includes a scalloped perimeter. The scalloped perimeter and necked down sheaves are aligned such that the bottom edge of the vertical side wall extends below top surfaces of the rollers.

Moreover, a necked down sheave for a roller of a conveyor system is described herein. The necked down sheave includes a housing, an axle that extends outwardly from the housing, and one or more bearings configured to enable the housing to rotate about the axle. The housing includes a proximal section, a distal section, and a necked down section disposed between the proximal section and the distal section. The proximal section is configured to be inserted within a tube portion of a roller. Moreover, an outer diameter of the necked down section is smaller than an outer diameter of the tube portion of the roller.

This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a perspective view of a portion of a conveyor system.

FIG. 2 is a top view of a portion of the conveyor system of FIG. 1.

FIG. 3 is a differing perspective view of a portion of the conveyor system of FIG. 1.

FIG. 4 is a side view of one of the rollers of the conveyor system of FIG. 1.

FIG. 5 a side view of a necked down sheave of the roller of FIG. 4.

FIG. 6 is an end view of the necked down sheave of FIG. 5.

FIG. 7 is a perspective view of a guardrail of the conveyor system of FIG. 1.

FIG. 8 is a perspective view of a portion of the conveyor system of FIG. 1 illustrating alignment between necked down sections of necked down sheaves and a scalloped perimeter of a bottom edge of the vertical side wall.

FIG. 9 is a zoomed in perspective view of part of the portion of the conveyor system illustrated in FIG. 8.

FIG. 10 is a side view of a portion of the conveyor system of FIG. 1 illustrating the alignment between the necked down sections of the necked down sheaves and the scalloped perimeter of the bottom edge of the vertical side wall.

### DETAILED DESCRIPTION

Various technologies pertaining to necked down roller sheaves for conveyor systems are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Terms such as “first” and “second” are used herein for identification purposes. These terms are not intended to imply any sort of order.

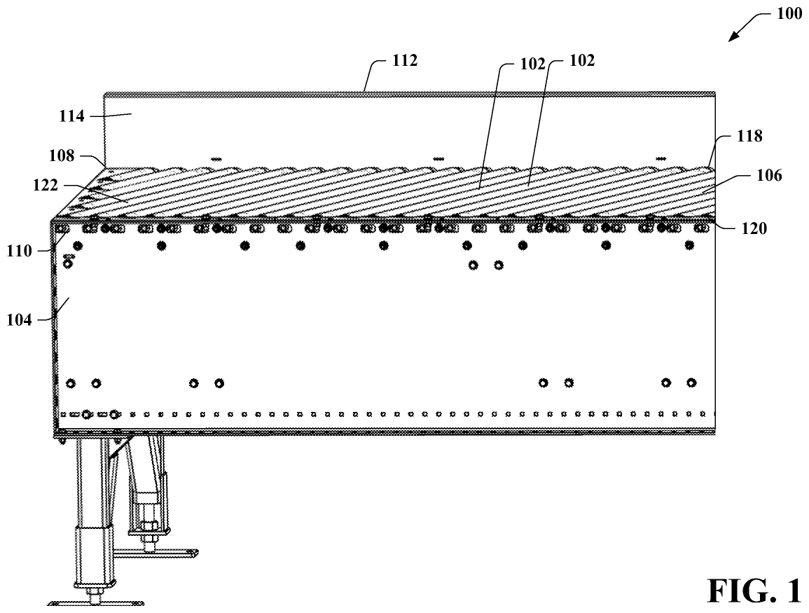

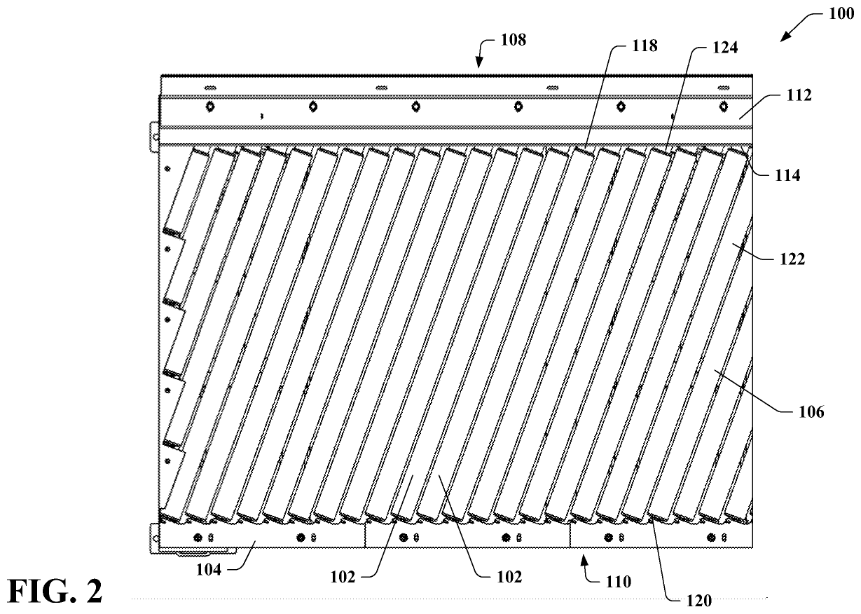

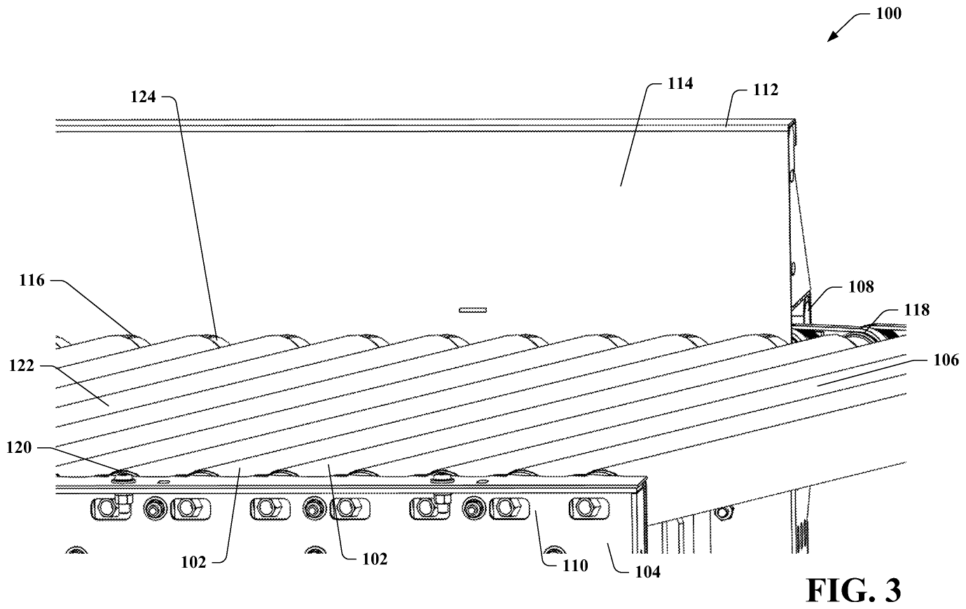

Now turning to the drawings, FIGS. 1-3 depict an exemplary embodiment of a conveyor system 100 that includes a plurality of tubular conveyor rollers 102. A perspective view of a portion of the conveyor system 100 is shown in FIG. 1, a top view of a portion of the conveyor system 100 is shown in FIG. 2, and a differing perspective view of a portion of the conveyor system 100 is shown in FIG. 3.

The rollers 102 are rotatingly mounted at preset intervals within a frame 104. The rollers 102 cooperate with each other to form a conveying surface 106 for conveying conveyed articles in a direction of travel along the conveyor system 100. As used herein, the term “direction of travel” is a path taken by the conveyed articles along a length or curvature of the conveyor system 100 from an infeed to an outfeed. Outer surfaces of the rollers 102 can form the conveying surface 106. The rollers 102 are mounted between a first side 108 of the frame 104 and an opposing second side 110 of the frame 104.

Moreover, the conveyor system 100 includes a guardrail 112. The guardrail 112 includes a vertical side wall 114. In the depicted example, the guardrail 112 is coupled to the first side 108 of the frame 104. Further, the conveying surface 106 is perpendicular to the vertical side wall 114 of the guardrail 112 (e.g., a plane that includes the conveying surface 106 is perpendicular to the vertical side wall 114).

In the conveyor system 100, the rollers 102 and the guardrail 112 are designed such that a bottom edge 116 of the vertical side wall 114 extends below top surfaces of the rollers 102. Thus, the bottom edge 116 of the vertical side wall 114 can extend below the conveying surface 106. Accordingly, the conveyor system 100 can lack a gap between a top of the conveying surface 106 and the bottom edge 116 of the vertical side wall 114. Since the bottom edge 116 of the vertical side wall 114 extends below the top of the conveying surface 106, any gap between the rollers 102 and the vertical side wall 114 would be below the conveyed articles transported along the conveying surface 106 by the rollers 102.

In contrast, conventional roller conveyor systems oftentimes have gaps between a top of a conveying surface (e.g., top of rollers) and a bottom edge of a vertical side wall of a guardrail. Such gaps included in conventional roller conveyor systems can detrimentally impact performance and safety. For example, a conveyed article being transported along a conventional conveying surface can become caught in the gap between the top of the conveying surface and the bottom edge of the vertical side wall, which can lead to the flow of conveyed articles becoming jammed. Moreover, the gap between the top of the conveying surface and the bottom edge of the vertical side wall in a conventional roller conveyor system can pose a risk for pinching an article of clothing or a body part (e.g., finger) of a person nearby the conventional roller conveyor system.

The rollers 102 can be skewed relative to the vertical side wall 114 (as shown in the depicted examples). If the rollers 102 are skewed, the conveyor system 100 can be an edge aligner conveyor system (e.g., conveyed articles can be conveyed by the rollers 102 both laterally and longitudinally across the conveyor surface 106 to align against the vertical side wall 114). Accordingly, axes of rotation of the rollers 102 and the vertical side wall 114 can be non-perpendicular. For instance, the top view of the conveyor system 100 shown in FIG. 2 depicts the axes of rotation of the rollers 102 and the vertical side wall 114 being non-perpendicular (e.g., within a plane defined by the axes of rotation of the rollers 102). Moreover, while the rollers 102 are skewed relative to the vertical side wall 114 as illustrated in FIG. 2, it is contemplated that the axes of rotation of the rollers 102 are vertically perpendicular with the vertical side wall 114 (e.g., the axes of rotation of the rollers 102 are in a plane that is perpendicular to the vertical side wall 114); thus, a top of the conveying surface 106 (e.g., a portion of the conveying surface 106 configured to contact the conveyed articles) is in a plane that is vertically perpendicular with the vertical side wall 114.

In other examples (not shown), it is contemplated that the axes of rotation of the rollers 102 and the vertical side wall 114 can be perpendicular; thus, the conveyor system 100 can be a straight conveyor system. Pursuant to these examples, conveyed articles can be longitudinally conveyed across the conveyor surface 106 (e.g., without being laterally conveyed from the second side 110 of the frame 104 towards the vertical side wall 114 at the first side 108 of the frame 104). For instance, such a straight conveyor system can be a section of an overall conveying system where conveyed articles are laterally pushed across the conveyor surface 106 from the second side 110 towards the vertical side wall 114 at the first side 108 by a person or mechanism separate from the conveyor system 100.

A skew angle as described herein refers to an angle between the axes of rotation of the rollers 102 and a normal to the vertical side wall 114 from the perspective of the top view of FIG. 2. Substantially any skew angle is intended to fall within the scope of the hereto appended claims. As noted above, a 0 degree skew angle refers to a straight conveyor system where the axes of rotation of the rollers 102 and the vertical side wall 114 are perpendicular. A non-zero degree skew angle refers to the axes of rotation of the rollers 102 and the vertical side wall 114 being non-perpendicular (as is depicted in many of the examples set forth herein). In some examples, the skew angle can be an angle in the range of 0 degrees to 45 degrees. According to an illustration, the skew angle can be 20 degrees; however, substantially any other skew angle is contemplated.

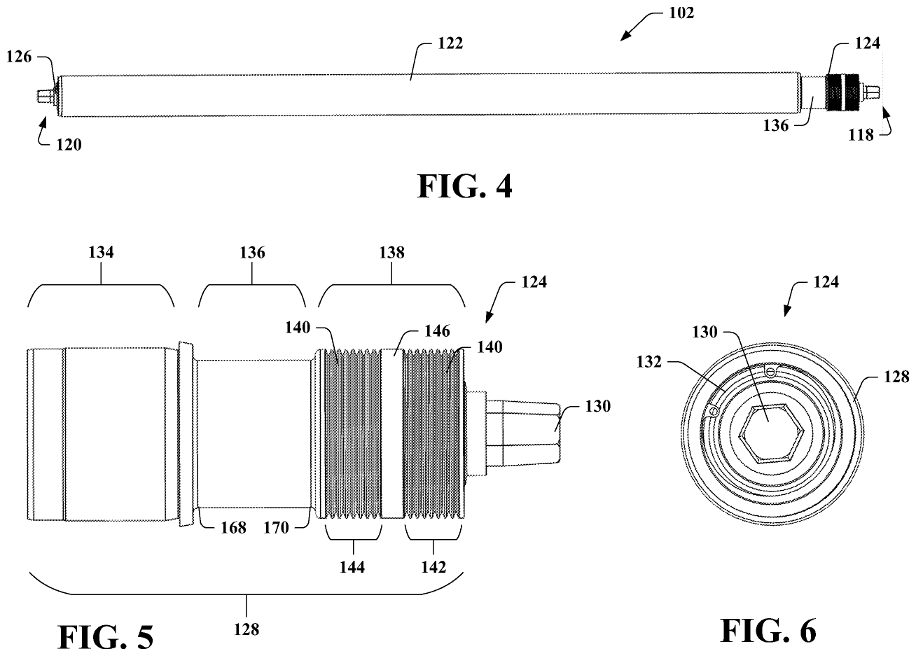

A drive end 118 of each of the rollers 102 is mounted to the first side 108 of the frame 104 and an opposing end 120 of each of the rollers 102 is mounted to the second side 110 of the frame 104. FIG. 4 illustrates a side view of one of the rollers 102 of the conveyor system 100. It is contemplated that each of the rollers 102 in the conveyor system 100 can be substantially similar to the roller 102 depicted in FIG. 4. Thus, the following description of the roller 102 of FIG. 4 can similarly apply to the other rollers 102 of the conveyor system 100.

The roller 102 includes a tube portion 122, a necked down sheave 124 mounted to the tube portion 122 at the drive end 118 of the roller 102, and a cartridge 126 (e.g., a bearing hub) mounted to the tube portion 122 at the opposing end 120 of the roller 102. The necked down sheave 124 is partially disposed within the tube portion 122 at the drive end 118. Likewise, the cartridge 126 can be partially disposed within the tube portion 122 at the opposing end 120. Although not shown, it is contemplated that a second sheave (e.g., a second necked down sheave) can be mounted to the tube portion 122 at the opposing end 120 of the roller 102 instead of the cartridge 126 in other embodiments (e.g., for all of the rollers 102 in the conveyor system 100, for a subset of the rollers 102 in the conveyor system 100 while a remainder of the rollers 102 can include the cartridge 126, etc.).

FIGS. 5-6 depict the necked down sheave 124 included in the roller 102. FIG. 5 illustrates a side view of the necked down sheave 124 and FIG. 6 illustrates an end view of the necked down sheave 124. The necked down sheave 124 includes a housing 128, an axle 130 that extends outwardly from the housing 128, and one or more bearings 132 configured to enable the housing 128 to rotate about the axle 130. Moreover, the housing 128 includes various sections, namely, a proximal section 134, a necked down section 136, and a distal section 138. The necked down section 136 is disposed between the proximal section 134 and the distal section 138. A proximal end 168 and a distal end 170 of the necked down section 136 define a width of the necked down section 136 along the housing 128 of the necked down sheave 124.

The proximal section 134 of the housing 128 of the necked down sheave 124 is configured to be inserted within the tube portion 122 of the roller 102. Accordingly, an outer diameter of the proximal section 134 of the necked down sheave 124 can correspond to an inner diameter of the tube portion 122 to enable the necked down sheave 124 to be mounted to the tube portion 122 at the drive end 118 of the roller 102. For example, the outer diameter of the proximal section 134 is sized so that the proximal section 134 can be inserted within and mechanically coupled to the tube portion 122 (e.g., the tube portion 122 and the housing 128 can be rotatably connected to rotate in unison about the axle 130).

The distal section 138 of the housing 128 of the necked down sheave 124 includes V-shaped grooves 140 formed on an outer surface thereof. The distal section 138 is divided into an outer grooved segment 142 and an inner grooved segment 144 divided by a partition 146. Both the outer grooved segment 142 and the inner grooved segment 144 include the V-shaped grooves 140 formed on the outer surface thereof, while the partition 146 between the outer grooved segment 142 and the inner grooved segment 144 lacks V-shaped grooves formed on the outer surface thereof.

The necked down section 136 of the housing 128 of the necked down sheave 124 has a smaller outer diameter than an outer diameter of the distal section 138 of the housing 128. Moreover, the outer diameter of the necked down section 136 can be smaller than the outer diameter of the proximal section 134. As shown in FIG. 4, the outer diameter of the necked down section 136 of the necked down sheave 124 is smaller than the outer diameter of the tube portion 122. The smaller outer diameter of the necked down section 136 of the housing 128 of the necked down sheave 124 (relative to the outer diameter of the distal section 138 and the outer diameter of the tube portion 122) enables the bottom edge 116 of the vertical side wall 114 to extend below the top surface of the conveying surface 106.

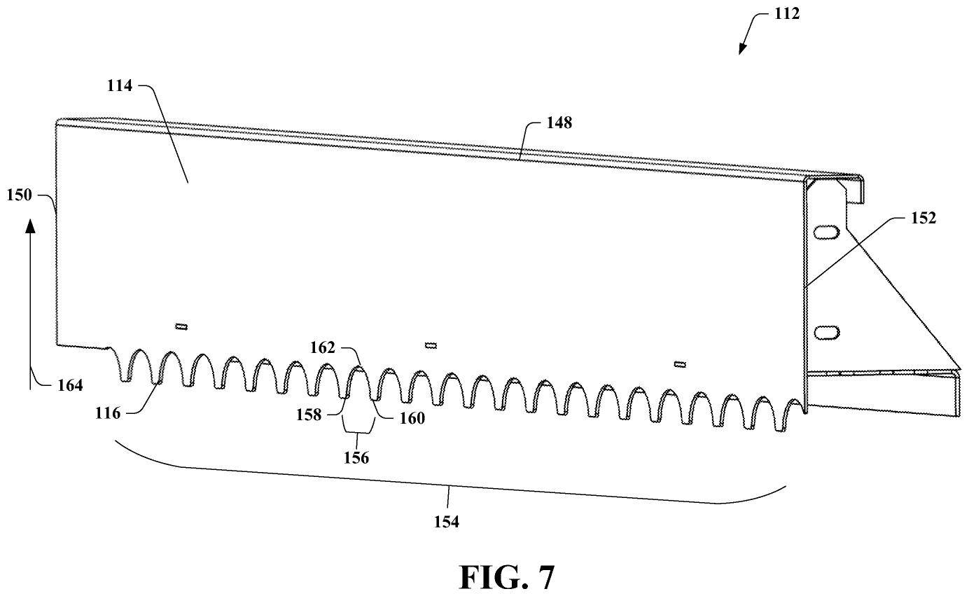

With reference to FIG. 7, illustrated is a perspective view of the guardrail 112 of the conveyor system 100. The guardrail 112 includes the vertical side wall 114; the vertical side wall 114 includes the bottom edge 116, a top edge 148 opposite the bottom edge 116, a first side edge 150, and a second side edge 152 opposite the first side edge 150. The bottom edge 116 extends between the first side edge 150 and the second side edge 152. Likewise, the top edge 148 extends between the first side edge 150 and the second side edge 152.

At least a portion of the bottom edge 116 of the vertical side wall 114 includes a scalloped perimeter 154. The scalloped perimeter 154 includes a series of repeating arc shaped curves. The arc shaped curves in the series along the scalloped perimeter 154 can each include a first endpoint, a second endpoint, and a midpoint between the first endpoint and the second endpoint. For example, an arc shaped curve 156 in the series along the scalloped perimeter 154 of the bottom edge 116 includes a first endpoint 158, a second endpoint 160, and a midpoint 162. The midpoint 162 can be equidistant between the first endpoint 158 and the second endpoint 160 along the arc shaped curve 156; however, not all of the arc shaped curves need to have equidistant midpoints. The endpoints of the arc shaped curves in the series along the scalloped perimeter 154 extend away from the top edge 148 relative to the midpoints of the arc shaped curves (e.g., the midpoints of the arc shaped curves are the points along the bottom edge 116 in each of the arc shaped curves closest to the top edge 148). Stated differently, heights of the vertical side wall 114 in a vertical direction (represented by arrow 164) between the top edge 148 and the bottom edge 116 at the endpoints of the arc shaped curves along the scalloped perimeter 154 are greater than heights of the vertical side wall 114 in the vertical direction between the top edge 148 and the bottom edge 116 at midpoints of the arc shaped curves along the scalloped perimeter 154.

The arc shaped curves along the scalloped perimeter 154 of the bottom edge 116 of the vertical side wall 114 are designed to align with the necked down section 136 of the housing 128 of the necked down sheave 124 of each of the rollers 102 in the conveyor system 100. Such alignment between the necked down sheaves 124 of the rollers 102 and the scalloped perimeter 154 of the bottom edge 116 of the vertical side wall 114 enable the bottom edge 116 to extend below top surfaces of the rollers 102 in the conveying surface 106.

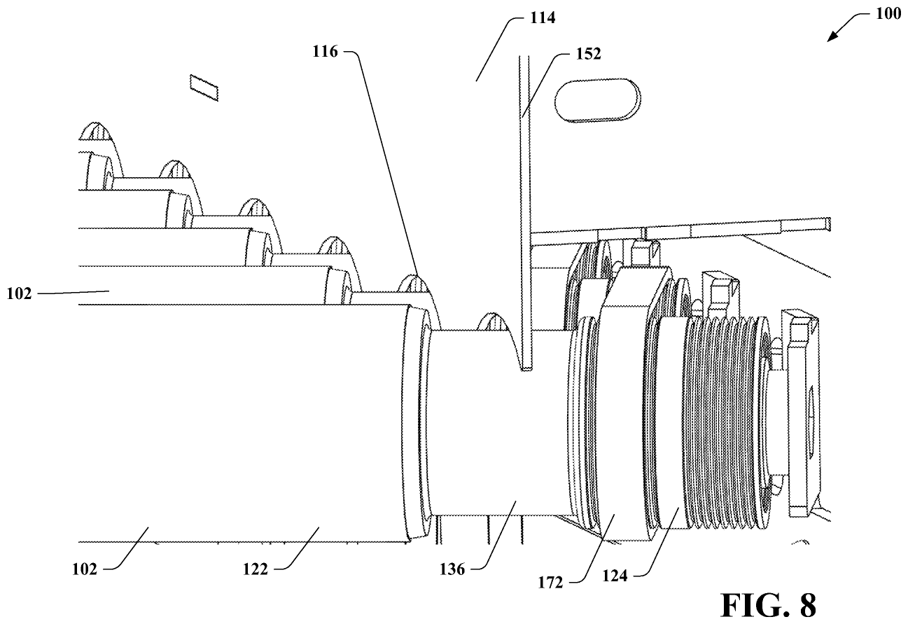

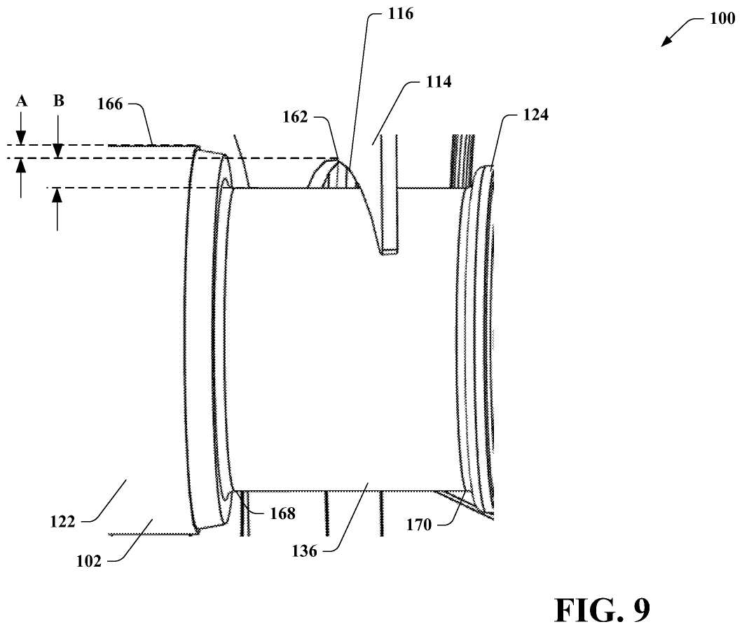

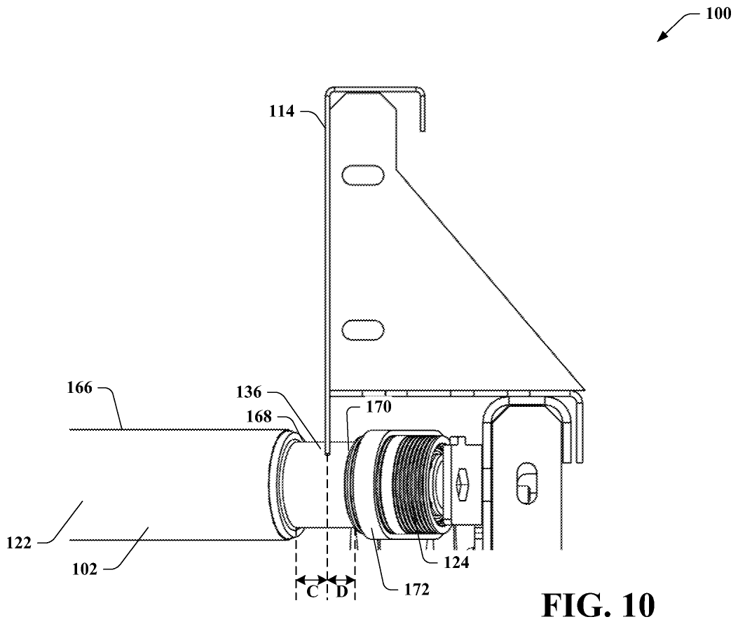

FIGS. 8-10 depict additional views of portions of the conveyor system 100. FIG. 8 shows a perspective view of a portion of the conveyor system 100 illustrating alignment between the necked down sections 136 of the necked down sheaves 124 and the scalloped perimeter 154 of the bottom edge 116 of the vertical side wall 114. FIG. 9 depicts a zoomed in perspective view of part of the portion of the conveyor system 100 illustrated in FIG. 8. Further, FIG. 10 shows a side view of a portion of the conveyor system 100 illustrating the alignment between the necked down sections 136 of the necked down sheaves 124 and the scalloped perimeter 154 of the bottom edge 116 of the vertical side wall 114.

Again, the necked down sheave 124 is mounted to the tube portion 122 of the roller 102. As the roller 102 rotates, a top of the tube portion 122 is represented as 166 in FIG. 9 (e.g., the top 166 of the tube portion 122 is along an outer diameter of the tube portion 122 of the roller 102). The top 166 of the tube portion 122 of the roller 102 across the plurality of rollers 102 in the conveyor system 100 can form the conveying surface 106 (e.g., the tops 166 of the tube portions 122 can contact the conveyed articles).

As shown in FIG. 9, the bottom edge 116 of the vertical side wall 114 extends below the top 166 of the tube portion 122 of the roller 102. In particular, a distance that a midpoint 162 of an arc shaped curve included in the scalloped perimeter 154 of the bottom edge 116 of the vertical side wall 114 is below the top 166 of the tube portion 122 of the roller 102 is represented by Dimension A in FIG. 9. Points other than the midpoints 162 along the arc shaped curves included in the scalloped perimeter 154 of the bottom edge 116 of the vertical side wall 114 are farther below the tops 166 of the tube portions 122 of the rollers 102; thus, the Dimension A is the minimum distance that the bottom edge 116 extends below the tops 166 of the tube portions 122 of the rollers 102. Accordingly, across the width of the vertical side wall 114 from the first side edge 150 to the second side edge 152, the bottom edge 116 extends below the tops 166 of the tube portions 122 of the rollers 102 by at least the Dimension A.

Further, Dimension B in FIG. 9 represents a clearance between the necked down section 136 of the necked down sheave 124 and the scalloped perimeter 154 of the bottom edge 116 of the vertical side wall 114. Pursuant to various examples, it can be desired to reduce Dimension B while maintaining clearance between the necked down section 136 of the necked down sheave 124 and the scalloped perimeter 154 of the bottom edge 116 of the vertical side wall 114 (e.g., Dimension B is to be a non-zero value). Accordingly, the outer diameter of the necked down section 136 of the necked down sheave 124 is smaller than the outer diameter of the tube portion 122 of the roller 122. A difference between the outer diameters of the necked down section 136 and the tube portion 122 can be a function of Dimension A and Dimension B (e.g., the difference between the outer diameters can be two times the sum of Dimension A plus Dimension B).

As noted above, a proximal end 168 and a distal end 170 of the necked down section 136 can define a width of the necked down section 136 along the housing 128 of the necked down sheave 124. FIG. 10 shows a side view of the vertical side wall 114. A Dimension C represents a distance between the vertical side wall 114 and the proximal end 168 of the necked down section 136, and a Dimension D represents a distance between the vertical side wall 114 and the distal end 170 of the necked down section 136. Dimension C corresponds to the skew angle of the axes of the rollers 102 relative to the vertical side wall 114 plus a thickness of material forming the vertical side wall 114. As noted above, in some examples, the skew angle can be an angle in the range of 0 degrees to 45 degrees. Dimension C is set such that the scalloped perimeter 154 of the bottom edge 116 of the vertical side wall 114 does not contact any portion of the housing 128 of the necked down sheave 124 (e.g., clearance is maintained between the scalloped perimeter 154 of the bottom edge 116 of the vertical side wall 114 and a portion of the housing 128 adjacent the proximal end 168 of the necked down section 136 towards the proximal section 134). Moreover, it can be desired to minimize the Dimension C while maintaining the aforementioned clearance. Further, Dimension D can be a variable distance. Accordingly, a width of the necked down section 136 can be a function of Dimension C plus Dimension D.

Reference is now generally made to FIGS. 1-10. Although not shown, it is contemplated that the conveyor system 100 further includes a drive assembly configured to drive the rollers 102. The drive assembly can include a motor, controls, safeties, power transmission, and the like.

Moreover, belts 172 (e.g., multi-V belts) are coupled to necked down sheaves 124 of the rollers 102. For instance, a directly driven roller in the rollers 102 can be driven by a motor. A first multi-V belt couples a necked down sheave of the directly driven roller to a necked down sheave of a first peripherally driven roller adjacent to the directly driven roller in the rollers 102. As a result, the first peripherally driven roller is driven by the directly driven roller. Further, a second multi-V belt couples the necked down sheave of the first peripherally driven roller to a necked down sheave of a second peripherally driven roller. Again, the second peripherally driven roller is driven by the first peripherally driven roller. The foregoing is repeated for a group of the rollers 102 (e.g., a number of adjacent rollers 102). Further, a multi-V belt can couple an inner grooved segment of a necked down sheave of a roller to an outer grooved segment of a necked down sheave of an adjacent roller. Moreover, the multi-V belt can engage the V-shaped grooves 140 of the adjacent rollers.

While many of the examples set forth herein describe the necked down sheave 124 including the V-shaped grooves 140, it is contemplated that other mechanisms for driving the rollers 102 are intended to fall within the scope of the hereto appended claims. Thus, in other embodiments, the distal section 138 of the housing 128 of the necked down sheave 124 can lack V-shaped grooves. For instance, O-ring transmission between adjacent rollers can be utilized in some embodiments (e.g., where the distal section 138 lacks the V-shaped grooves). However, it is to be appreciated that any other mechanism for driving the rollers 102 is intended to fall with the scope of the claimed subject matter.

Further, while many of the examples described herein include the necked down sheave 124 being a cartridge insertable into the tube portion 122, in other embodiments it is contemplated that the tube portion 122 and the necked down sheave 124 can be a continuously machined piece. Accordingly, in such embodiments, the tube portion 122 and the necked down sheave 124 (or at least a portion thereof such as at least the housing 128 of the necked down sheave 124) can be a continuously machined surface.

Described herein are various technologies according to at least the following examples.
(A1) In an aspect, a conveyor system includes a frame having a first side and an opposing second side. The conveyor system further includes a plurality of rollers mounted between the first side of the frame and the opposing second side of the frame, the rollers forming a conveying surface, the rollers comprising respective tube portions and necked down sheaves mounted to the tube portions. The conveyor system also includes a guardrail comprising a vertical side wall. The guardrail is coupled to the first side of the frame. The vertical side wall of the guardrail is perpendicular to the conveying surface. The vertical side wall comprising a bottom edge, wherein at least a portion of the bottom edge of the vertical side wall includes a scalloped perimeter, wherein the scalloped perimeter and necked down sheaves are aligned such that the bottom edge of the vertical side wall extends below top surfaces of the rollers.
(A2) In some embodiments of the conveyor system of (A1), the necked down sheaves are partially disposed within the tube portions.
(A3) In some embodiments of the conveyor system of at least one of (A1)-(A2), each of the necked down sheaves comprises a housing, an axle that extends outwardly from the housing, and one or more bearings configured to enable the housing to rotate about the axle. The housing comprises a proximal section, a distal section, and a necked down section disposed between the proximal section and the distal section. The proximal section is inserted within a tube portion of a roller. An outer diameter of the necked down section is smaller than an outer diameter of the tube portion of the roller.
(A4) In some embodiments of the conveyor system of (A3), the distal section of the housing comprises V-shaped grooves formed on an outer surface thereof.
(A5) In some embodiments of the conveyor system of at least one of (A3)-(A4), the distal section of the housing comprises an outer grooved segment, an inner grooved segment, and a partition between the outer grooved segment and the inner grooved segment, and wherein the outer grooved segment and the inner grooved segment comprise V-shaped grooves.
(A6) In some embodiments of the conveyor system of at least one of (A3)-(A5), an outer diameter of the proximal section is sized so that the proximal section is inserted within and mechanically coupled to the tube portion such that the tube portion and the housing are rotatably connected to rotate in unison about the axle.
(A7) In some embodiments of the conveyor system of at least one of (A3)-(A6), a width of the necked down section is set based on a skew angle of axes of rotation of the rollers relative to the vertical side wall and a thickness of material forming the vertical side wall.
(A8) In some embodiments of the conveyor system of at least one of (A1)-(A7), the scalloped perimeter of the bottom edge of the vertical side wall comprises a series of repeating arc shaped curves.
(A9) In some embodiments of the conveyor system of (A8), the vertical side wall further comprises a top edge opposite the bottom edge, and the arc shaped curves in the series along the scalloped perimeter each include a first endpoint, a second endpoint, and a midpoint between the first endpoint and the second endpoint such that the first endpoint and the second endpoint extend away from the top edge relative to the midpoint.
(A10) In some embodiments of the conveyor system of (A9), the midpoint is equidistant between the first endpoint and the second endpoint along a corresponding arc shaped curve.
(A11) In some embodiments of the conveyor system of at least one of (A1)-(A10), the rollers are skewed relative to the vertical side wall such that axes of rotation of the rollers and the vertical side wall are non-perpendicular within a plane defined by the axes of rotation of the rollers.
(A12) In some embodiments of the conveyor system of at least one of (A1)-(A11), the necked down sheaves are mounted to the tube portions at drive ends of the rollers, and the rollers further comprise respective cartridges mounted to the tube portions at opposing ends of the rollers.
(A13) In some embodiments of the conveyor system of (A12), the cartridges are partially disposed within the tube portions.
(A14) In some embodiments of the conveyor system of at least one of (A1)-(A13), axes of rotation of the rollers are vertically perpendicular with the vertical side wall.
(A15) In some embodiments of the conveyor system of at least one of (A1)-(A14), the conveyor system being an edge aligner conveyor system.
(A16) In some embodiments of the conveyor system of at least one of (A1)-(A15), the conveyor system lacks a gap between a top of the conveying surface and the bottom edge of the vertical side wall.
(B1) In yet another aspect, a necked down sheave includes a housing, an axle that extends outwardly from the housing, and one or more bearings configured to enable the housing to rotate about the axle. The housing comprises a proximal section, a distal section, and a necked down section disposed between the proximal section and the distal section. The proximal section is configured to be inserted within a tube portion of a roller. An outer diameter of the necked down section is smaller than an outer diameter of the tube portion of the roller.
(B2) In some embodiments of the necked down sheave of (B1), the distal section of the housing comprises V-shaped grooves formed on an outer surface thereof.
(B3) In some embodiments of the necked down sheave of at least one of (B1)-(B2), the distal section of the housing comprises an outer grooved segment, an inner grooved segment, and a partition between the outer grooved segment and the inner grooved segment, and wherein the outer grooved segment and the inner grooved segment comprise V-shaped grooves.
(B4) In some embodiments of the necked down sheave of at least one of (B1)-(B3), an outer diameter of the proximal section is sized so that the proximal section is inserted within and mechanically coupled to the tube portion such that the tube portion and the housing are rotatably connected to rotate in unison about the axle.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A conveyor system, comprising:
a frame having a first side and an opposing second side;
a plurality of rollers mounted between the first side of the frame and the opposing second side of the frame, the rollers forming a conveying surface, the rollers comprising respective tube portions and necked down sheaves mounted to the tube portions; and
a guardrail comprising a vertical side wall, the guardrail being coupled to the first side of the frame, the vertical side wall of the guardrail being perpendicular to the conveying surface, the vertical side wall comprising a bottom edge, at least a portion of the bottom edge of the vertical side wall includes a scalloped perimeter, wherein the scalloped perimeter and necked down sheaves are aligned such that the bottom edge of the vertical side wall extends below top surfaces of the rollers.

2. The conveyor system of claim 1, wherein the necked down sheaves are partially disposed within the tube portions.

3. The conveyor system of claim 1, wherein each of the necked down sheaves comprises:
a housing;
an axle that extends outwardly from the housing; and
one or more bearings configured to enable the housing to rotate about the axle;
wherein the housing comprises a proximal section, a distal section, and a necked down section disposed between the proximal section and the distal section;
wherein the proximal section is inserted within a tube portion of a roller; and
wherein an outer diameter of the necked down section is smaller than an outer diameter of the tube portion of the roller.

4. The conveyor system of claim 3, wherein the distal section of the housing comprises V-shaped grooves formed on an outer surface thereof.

5. The conveyor system of claim 3, wherein the distal section of the housing comprises an outer grooved segment, an inner grooved segment, and a partition between the outer grooved segment and the inner grooved segment, and wherein the outer grooved segment and the inner grooved segment comprise V-shaped grooves.

6. The conveyor system of claim 3, wherein an outer diameter of the proximal section is sized so that the proximal section is inserted within and mechanically coupled to the tube portion such that the tube portion and the housing are rotatably connected to rotate in unison about the axle.

7. The conveyor system of claim 3, wherein a width of the necked down section is set based on a skew angle of axes of rotation of the rollers relative to the vertical side wall and a thickness of material forming the vertical side wall.

8. The conveyor system of claim 1, wherein the scalloped perimeter of the bottom edge of the vertical side wall comprises a series of repeating arc shaped curves.

9. The conveyor system of claim 8, wherein:
the vertical side wall further comprises a top edge opposite the bottom edge; and
the arc shaped curves in the series along the scalloped perimeter each include a first endpoint, a second endpoint, and a midpoint between the first endpoint and the second endpoint such that the first endpoint and the second endpoint extend away from the top edge relative to the midpoint.

10. The conveyor system of claim 9, wherein the midpoint is equidistant between the first endpoint and the second endpoint along a corresponding arc shaped curve.

11. The conveyor system of claim 1, wherein the rollers are skewed relative to the vertical side wall such that axes of rotation of the rollers and the vertical side wall are non-perpendicular within a plane defined by the axes of rotation of the rollers.

12. The conveyor system of claim 1, wherein the necked down sheaves are mounted to the tube portions at drive ends of the rollers, and wherein the rollers further comprise respective cartridges mounted to the tube portions at opposing ends of the rollers.

13. The conveyor system of claim 12, wherein the cartridges are partially disposed within the tube portions.

14. The conveyor system of claim 1, wherein axes of rotation of the rollers are vertically perpendicular with the vertical side wall.

15. The conveyor system of claim 1, being an edge aligner conveyor system.

16. The conveyor system of claim 1, wherein the conveyor system lacks a gap between a top of the conveying surface and the bottom edge of the vertical side wall.

17. A necked down sheave, comprising:
a housing;
an axle that extends outwardly from the housing; and
one or more bearings configured to enable the housing to rotate about the axle;
wherein the housing comprises a proximal section, a distal section, and a necked down section disposed between the proximal section and the distal section;
wherein the proximal section is configured to be inserted within a tube portion of a roller; and
wherein an outer diameter of the necked down section is smaller than an outer diameter of the tube portion of the roller.

18. The necked down sheave of claim 17, wherein the distal section of the housing comprises V-shaped grooves formed on an outer surface thereof.

19. The necked down sheave of claim 17, wherein the distal section of the housing comprises an outer grooved segment, an inner grooved segment, and a partition between the outer grooved segment and the inner grooved segment, and wherein the outer grooved segment and the inner grooved segment comprise V-shaped grooves.

20. The necked down sheave of claim 17, wherein an outer diameter of the proximal section is sized so that the proximal section is inserted within and mechanically coupled to the tube portion such that the tube portion and the housing are rotatably connected to rotate in unison about the axle.
